(19) United States
(12) Patent Application Publication
(10) Pub. No.: US 2006/0268186 A1
(43) Pub. Date: Nov. 30, 2006

(54) Substrate for liquid crystal display device, liquid crystal display device having same, and driving method of liquid crystal display device

(76) Inventors: Tsuyoshi Kamada, Kawasaki (JP); Yohei Nakanishi, Kawasaki (JP); Kazuya Ueda, Kawasaki (JP); Hidefumi Yoshida, Kawasaki (JP); Hideaki Tsuda, Kawasaki (JP)

Correspondence Address: HARNESS, DICKEY & PIERCE, P.L.C., P.O. BOX 8910, RESTON, VA, 20195, US

(21) Appl. No.: 11/313,669

(22) Filed: Dec. 22, 2005

(30) Foreign Application Priority Data
Dec. 28, 2004 (JP) 2004-380006

(51) Int. Cl. G02F 1/1343

(52) U.S. Cl. 349/38

(57) ABSTRACT

The invention relates to a substrate for a liquid crystal display device, a liquid crystal display device having the substrate, and a driving method of a liquid crystal display device and provide a substrate for a liquid crystal display device capable of providing superior display characteristics, a liquid crystal display device having it, and a driving method of a liquid crystal display device. A substrate for a liquid crystal display device is provided with a pixel region having first sub-pixels in which respective first pixel electrodes are formed and a second sub-pixel in which a second pixel electrode is formed, a first TFT having a gate electrode that is connected to an nth gate bus line and a source electrode that is connected the first pixel electrodes, a second TFT having a gate electrode that is connected to an (n−1)th gate bus line, a drain electrode that is connected to the source electrode of the first TFT, and a source electrode that is connected to the second pixel electrode, and a control capacitance section which establishes capacitive coupling between the source electrode of the first TFT and the second pixel electrode.

### BACKGROUND OF THE INVENTION

1. Field of the Invention

The present invention relates to a substrate for a liquid crystal display device used as, for example, a display unit of an electronic apparatus, a liquid crystal display device having the substrate, and a driving method of a liquid crystal display device.

2. Description of the Related Art

In recent years, liquid crystal display devices have come to be used for TV receivers, monitor devices of personal computers, etc. In these purposes, liquid crystal display devices are required to have a good viewing angle characteristic that the display screen is viewable from all directions. FIG. 23 is a graph showing transmittance vs. application voltage characteristics (T-V characteristics) of a VA (vertically aligned)-mode liquid crystal display device. The horizontal axis represents the voltage (V) applied to the liquid crystal layer and the vertical axis represents the light transmittance. Line A is a T-V characteristic in the direction perpendicular to the display screen (hereinafter referred to as “front direction”), and line B is a T-V characteristic in a direction having an azimuth angle of 90° and a polar angle of 60° with respect to the display screen (hereinafter referred to as “oblique direction”). The azimuth angle is measured counterclockwise from the rightward direction of the display screen and the polar angle is measured from the perpendicular to the display screen at the center.

As shown in FIG. 23, distortion exists in transmittance (luminance) variations in a region enclosed by circle C and its neighborhood. For example, whereas the transmittance in the oblique direction is higher than that in the front direction at a relatively low gradation level (application voltage: about 2.5 V), the transmittance in the oblique direction is lower than that in the front direction at a relatively high gradation level (application voltage: about 4.5 V). As a result, when the display screen is viewed in the oblique direction, luminance differences in an effective drive voltage range are small. This phenomenon is most remarkable in color variations.

FIGS. 24A and 24B show a difference in visual recognition between images displayed on the display screen. FIG. 24A shows an image as viewed in the front direction and FIG. 24B shows an image as viewed in the oblique direction. As seen from FIGS. 24A and 24B, the image looks more whitish when viewed in the oblique direction than when viewed in the front direction.

FIGS. 25A to 25C are gradation histograms of the three primary colors of red (R), green (G), and blue (B) of a reddish image, respectively. The horizontal axes of FIGS. 25A to 25C represent the gradation (256 gradations (0 to 255)) and their vertical axes represent the percentage of presence. As seen from FIGS. 25A to 25C, in this image, relatively high gradation levels of R exist at high percentages and relatively low gradation levels of G and B exist at high percentages. If this kind of image is displayed on the display screen of a VA-mode liquid crystal display device and viewed in the oblique direction, R (high gradation levels) looks relatively darker and G and B (low gradation levels) look relatively brighter. Since the luminance differences between the three primary colors decrease, the image looks whitish as a whole.

The above phenomenon occurs in a similar manner also in liquid crystal display devices of the TN (twisted nematic) mode, which is an older drive mode. JP-A-2-12 (Patent Reference 1), U.S. Pat. No. 4,840,460 (Patent Reference 2), and Japanese Patent No. 3,076,938 (Patent Reference 3) disclose techniques for suppressing the above phenomenon in TN-mode liquid crystal display devices. FIG. 26 shows the configuration of one pixel of a basic liquid crystal display device according to these related art references. FIG. 27 is a sectional view taken along line X-X in FIG. 26. FIG. 28 shows an equivalent circuit of the one pixel of the liquid crystal display device. As shown in FIGS. 26 to 28, the liquid crystal display device has a thin-film transistor (TFT) substrate 102, an opposite substrate 104, and a liquid crystal layer 106 which is sealed between the substrates 102 and 104.

The TFT substrate 102 has a plurality of gate bus lines 112 formed on a glass substrate 110 and a plurality of drain bus lines 114 formed so as to cross the gate bus lines 112 with an insulating film 130 interposed in between. A TFT 120 which is formed as a switching element for each pixel is disposed close to the crossing point of each set of a gate bus line 112 and a drain bus line 114. Part of the gate bus line 112 associated with the TFT 120 functions as a gate electrode of the TFT 120, and a drain electrode 121 of the TFT 120 is electrically connected to the associated drain bus line 114. A storage capacitor bus line 118 is formed so as to traverse a pixel region defined by the gate bus lines 112 and the drain bus lines 114 and to extend parallel with the gate bus lines 112. A storage capacitor electrode 119 which is provided for each pixel is formed above the storage capacitor bus line 118 with the insulating film 130 interposed in between. The storage capacitor electrode 119 is electrically connected to a source electrode 122 of the TFT 120 via a control capacitance electrode 125. A storage capacitor Cs is formed between the storage capacitor bus line 118 and the storage capacitor electrode 119.

The pixel region which is defined by the gate bus lines 112 and the drain bus lines 114 is divided into sub-pixels A and B. A pixel electrode 116 is formed in the sub-pixel A, and a pixel electrode 117 which is separated from the pixel electrode 116 is formed in the sub-pixel B. The pixel electrode 116 is electrically connected to the storage capacitor electrode 119 and the source electrode 122 of the TFT 120 via a contact hole 124. On the other hand, the pixel electrode 117 is in an electrically floating state. The pixel electrode 117 has a region that coextends with part of the control capacitance electrode 125 via a protective film 132, and the pixel electrode 117 is connected indirectly to the source electrode 122 via a control capacitance Cc formed in this region (capacitive coupling).

The counter electrode 104 has a color filter (CF) resin layer 140 formed on a glass substrate 111 and a common electrode 142 formed on the CF resin layer 140. A liquid crystal capacitance Clc1 is formed between the pixel electrode 116 of the sub-pixel A and the common electrode 142, and a liquid crystal capacitance Clc2 is formed between the pixel electrode 117 of the sub-pixel B and the common electrode 142. Alignment films 136 and 137 are formed at the interfaces between the TFT substrate 102 and the liquid crystal layer 106 and between the opposite substrate 104 and the liquid crystal layer 106, respectively.

Now assume that the TFT 120 has been turned on, whereby a voltage is applied to the pixel electrode 116, that is, a voltage Vpx1 develops across a portion of the liquid crystal layer 106 corresponding to the sub-pixel A. Since the voltage Vpx1 is divided according to the capacitance ratio of the liquid crystal capacitance Clc2 and the control capacitance Cc, a voltage that is applied to the pixel electrode 117 of the sub-pixel B is different from the voltage applied to the pixel electrode 116. A voltage Vpx2 that develops across a portion of the liquid crystal layer 106 corresponding to the sub-pixel B is given by
Vpx2={Cc/(Clc2+Cc)}×Vpx1.

It is ideal that the voltage ratio Vpx2/Vpx1 (=Cc/(Clc2+Cc)), which is a design item that should be set according to intended display characteristics of an actual liquid crystal display device, be set approximately at 0.6 to 0.8.

Where as described above each pixel has the sub-pixels A and B in which different voltages develop across the corresponding portions of the liquid crystal layer 106, the distortion in the T-V characteristic as shown in FIG. 23 is shared between the sub-pixels A and B. Therefore, the phenomenon that an image looks whitish when viewed in an oblique direction is suppressed and the viewing angle characteristic is improved. The above technique will be referred to below as “capacitive coupling HT (halftone/gray scale) technique.”

Although in Patent References 1-3 the above technique is discussed for TN-mode liquid crystal display devices, its effect is enhanced if the above technique is applied to a liquid crystal display device of the VA mode which has become the mainstream mode in recent years in place of the TN mode.

FIGS. 29A to 29D illustrate a burn-in phenomenon occurring in a conventional liquid crystal display device that employs the capacitive coupling HT technique. FIG. 29A shows a black-and-white checkered pattern that was displayed on the screen in a burn-in test. In the burn-in test, a halftone image (32/64 gradations) of the same gradation level was displayed over the entire screen immediately after the checkered pattern of FIG. 29A had been displayed continuously for a prescribed time (e.g., 48 hours) and it was checked whether a checkered pattern was seen. If a checkered pattern was seen, the luminance of the screen was measured along one direction of a checkered pattern and a burn-in factor was calculated. The burn-in factor is defined as b/a where a is luminance of low-luminance regions of a visually recognized checkered pattern and a+b (>a) is luminance in high-luminance regions.

FIG. 29B shows a state of the screen on which a halftone image was displayed in a liquid crystal display device that did not employ the capacitive coupling HT technique. FIG. 29C shows a state of the screen on which a halftone image was displayed in a conventional liquid crystal display device that employed the capacitive coupling HT technique. As shown in FIG. 29B, a checkered pattern was hardly seen in the liquid crystal display device that did not employ the capacitive coupling HT technique when a half tone image was displayed. When the luminance was measured along line Y-Y′ in FIG. 29B, a luminance distribution represented by line c in FIG. 29D was obtained. The burn-in factor was as small as 0% to 5%. In contrast, a checkered pattern as shown in FIG. 29C was seen in the liquid crystal display device that employed the capacitive coupling HT technique. When the luminance was measured along line Y-Y′ in FIG. 29C, a luminance distribution represented by line d in FIG. 29D was obtained. The burn-in factor was 10% or larger. As is understood from this test, whereas almost, no burn-in occurs in a liquid crystal display device that does not employ the capacitive coupling HT technique, a relatively high degree of burn-in occurs in a liquid crystal display device that employs the capacitive coupling HT technique.

A burn-in distribution in each pixel and other items of liquid crystal display devices where a burn-in phenomenon occurred were evaluated and an analysis was done. And it was found that the burn-in phenomenon occurs in the sub-pixels B where the pixel electrode 117 is formed which is in an electrically floating state. The pixel electrode 117 is connected to the control capacitance electrode 125 via a silicon nitride film (SiN film) or the like having a very high electrical resistance and is connected to the common electrode 142 via the liquid crystal layer 106 also having a very high electrical resistance. Therefore, charge accumulated in the pixel electrode 117 is not released easily. On the other hand, a prescribed voltage is written frame-by-frame to the pixel electrode 116 of the sub-pixel A which is electrically connected to the source electrode 122 of the TFT 120 and the pixel electrode 116 is connected to the drain bus line 114 via the operation semiconductor layer of the TFT 120 which much lower in electrical resistance than the SiN film and the liquid crystal layer 106. Therefore, there does not occur an event that charge accumulated in the pixel electrode 116 is not released.

As described above, conventional liquid crystal display devices that employ the capacitive coupling HT technique have a problem that they cannot provide superior display characteristics because of occurrence of the burn-in phenomenon though their viewing angle characteristic is good.

JP-A-8-146464 is another related art patent reference relating to the invention.

### SUMMARY OF THE INVENTION

An object of the present invention is therefore to provide a substrate for a liquid crystal display device capable of providing superior display characteristics, a liquid crystal display device having it, and a driving method of a liquid crystal display device.

The above object is attained by a substrate for a liquid crystal display device, comprising a plurality of gate bus lines formed parallel with each other on a substrate; a plurality of drain bus lines formed so as to cross the gate bus lines with an insulating film interposed in between; a pixel region having a first sub-pixel in which a first pixel electrode is formed on the substrate and a second sub-pixel in which a second pixel electrode is formed on the substrate so as to be separated from the first pixel electrode; a first transistor having a gate electrode that is electrically connected to an nth one of the gate bus lines, a drain electrode that is electrically connected to one of the drain bus lines, and a source electrode that is electrically connected to the first pixel electrode; a second transistor having a gate electrode that is electrically connected to an (n−1)th one of the gate bus lines, a drain electrode that is electrically connected to one of the source electrode of the first transistor and the second pixel electrode, and a source electrode that is electrically connected to the other of the source electrode of the first transistor and the second pixel electrode; and a control capacitance section which has a control capacitance electrode electrically connected to the source electrode of the first transistor and is opposed to at least part of the second pixel electrode via an insulating film, and thereby establishes capacitive coupling between the source electrode of the first transistor and the second pixel electrode.

The invention can realize a liquid crystal display device capable of providing superior display characteristics.

### BRIEF DESCRIPTION OF THE DRAWINGS

FIG. 1 schematically shows the configuration of a liquid crystal display device according to a first embodiment of the present invention;

FIG. 2 shows the configuration of one pixel of a substrate for a liquid crystal display device according to the first embodiment of the invention;

FIG. 3 is a sectional view, taken along line C-C in FIG. 2, of the liquid crystal display device according to the first embodiment of the invention;

FIG. 4 shows an equivalent circuit of one pixel of the liquid crystal display device according to the first embodiment of the invention;

FIG. 5 shows drive waveforms used in the liquid crystal display device according to the first embodiment of the invention;

FIGS. 6A to 6C illustrate how a TFT 22 of the liquid crystal display device according to the first embodiment of the invention operates and the voltages of individual capacitors vary;

FIG. 7 is a graph showing voltage variations of pixel electrodes of sub-pixels A and B of a liquid crystal display device;

FIG. 8 is a graph showing how a voltage ratio Vpx2/Vpx1 varies as a capacitance ratio Cc/Clc2 is varied;

FIG. 9 is a graph showing how the voltage Vpx1 and the luminance vary over time;

FIG. 10 is a graph showing how the voltage Vpx1 and the luminance vary over time in the case where a driving method according to the first embodiment of the invention is used;

FIG. 11 shows the configuration of one pixel of an MVA-type liquid crystal display device according to the first embodiment of the invention;

FIG. 12 is a sectional view of the MVA-type liquid crystal display device according to the first embodiment of the invention;

FIG. 13 shows the configuration of one pixel of a substrate for a liquid crystal display device according to a second embodiment of the invention;

FIG. 14 shows an equivalent circuit of one pixel of a liquid crystal display device according to the second embodiment of the invention;

FIGS. 15A to 15C illustrate how a TFT 22 of the liquid crystal display device according to the second embodiment of the invention operates and the voltages of individual capacitors vary;

FIG. 16 is a graph showing voltage variations of pixel electrodes of sub-pixels A and B of a liquid crystal display device;

FIG. 17 is a graph showing how a voltage ratio Vpx2/Vpx1 varies as a capacitance ratio Cc/Clc2 is varied;

FIG. 18 is a graph showing voltage variations of pixel electrodes of sub-pixels A and B of the liquid crystal display device according to the second embodiment of the invention;

FIG. 19 is a graph showing how the voltage Vpx1 and the luminance vary over time;

FIG. 20 is a graph showing how the voltage Vpx1 and the luminance vary over time;

FIG. 21 is a graph showing how the voltage Vpx1 and the luminance vary over time;

FIG. 22 shows an equivalent circuit of one pixel of a liquid crystal display device according to a third embodiment of the invention;

FIG. 23 is a graph showing T-V characteristics of a VA-mode liquid crystal display device;

FIGS. 24A and 24B show a difference in visual recognition between images displayed on the display screen;

FIGS. 25A to 25C are gradation histograms of the three primary colors of R, G, and B of a reddish image, respectively;

FIG. 26 shows the configuration of one pixel of a basic liquid crystal display device according to related art references;

FIG. 27 is a sectional view of a basic liquid crystal display device according to related art references;

FIG. 28 shows an equivalent circuit of the one pixel of the liquid crystal display device according to related art references; and

FIGS. 29A to 29D illustrate a burn-in phenomenon occurring in a conventional liquid crystal display device that employs the capacitive coupling HT technique.

### DESCRIPTION OF THE PREFERRED EMBODIMENTS

### First Embodiment

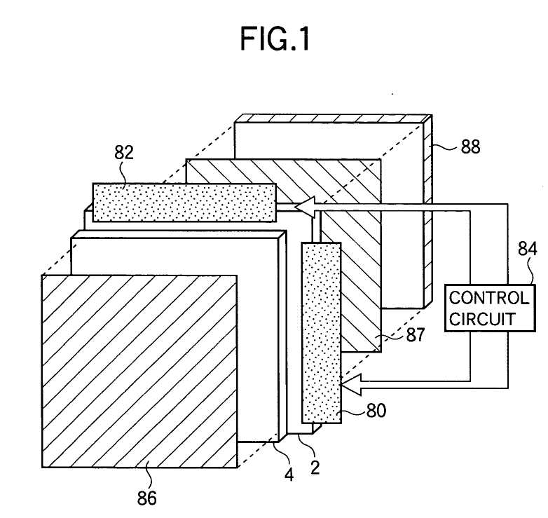

A substrate for a liquid crystal display device, a liquid crystal display device having it, and a driving method of a liquid crystal display device according to a first embodiment of the present invention will be hereinafter described with reference to FIGS. 1 to 12. FIG. 1 schematically shows the configuration of the liquid crystal display device according to the embodiment. As shown in FIG. 1, the liquid crystal display device has a TFT substrate 2 which is provided with gate bus lines and drain bus lines that cross each other with an insulating film interposed in between, TFTs that are formed for respective pixels, and pixel electrodes. The liquid crystal display device is also equipped with an opposite substrate 4 in which CFs and a common electrode are formed and a liquid crystal 6 (not shown in FIG. 1) that is sealed between the substrates 2 and 4 and has negative dielectric anisotropy, for example.

A gate bus line driving circuit 80 incorporating a driver IC for driving the a plurality of gate bus lines and a drain bus line driving circuit 82 incorporating a driver IC for driving the a plurality of drain bus lines are connected to the TFT substrate 2. The driving circuits 80 and 82 output scanning signals and data signals to prescribed gate bus lines and drain bus lines on the basis of prescribed signals that are output from a control circuit 84. A polarizing plate 87 is disposed on that surface of the TFT substrate 2 which is opposite to its TFT elements formation surface and a polarizing plate 86 is disposed on that surface of the opposite substrate 4 which is opposite to its common electrode formation surface, the polarizing plates 86 and 87 being in a crossed-Nicols arrangement. A backlight unit 88 is disposed on that surface of the polarizing plate 87 which is opposite to the TFT substrate 2.

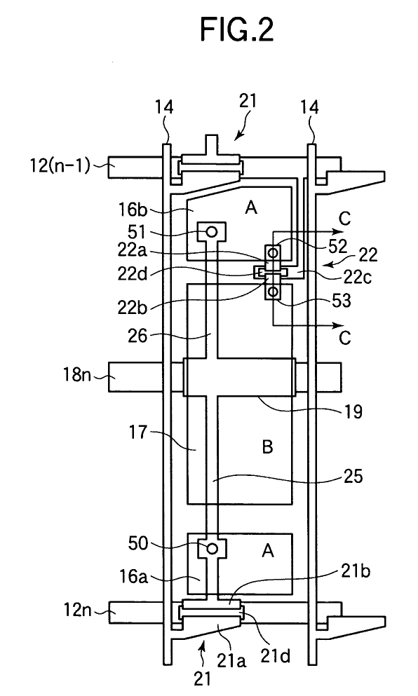

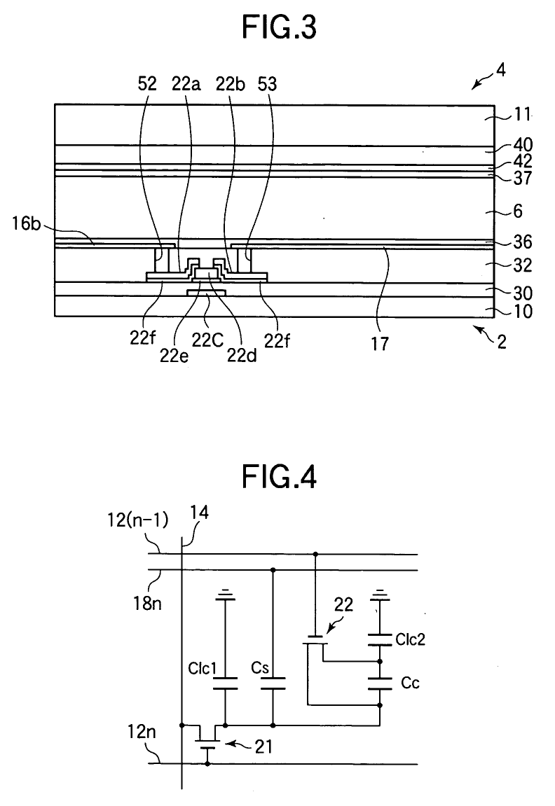

FIG. 2 shows the configuration of one nth-row pixel of a substrate for a liquid crystal display device according to the embodiment. FIG. 3 is a sectional view, taken along line C-C in FIG. 2, of the liquid crystal display device according to the embodiment. FIG. 4 shows an equivalent circuit of the one nth-row pixel of the liquid crystal display device according to the embodiment. As shown in FIGS. 2 to 4, the TFT substrate 2 has a plurality of gate bus lines 12 which are formed on a glass substrate 10 and a plurality of drain bus lines 14 which are formed so as to cross the gate bus lines 12 with an insulating film 30 (an SiN film or the like) interposed in between. For example, the a plurality of gate bus lines 12 are scanned line-sequentially. FIGS. 2 to 4 show an (n−1)th gate bus line 12(n−1) which is scanned (n−1)thly and an nth gate bus line 12n which is scanned nthly. Each region enclosed by gate bus lines 12 and drain bus lines 14 is a pixel region. Although in general an nth-row pixel region is formed between gate bus lines 12n and 12(n+1), in this embodiment an nth-row pixel region is formed between gate bus lines 12(n−1) and 12n.

A first TFT 21 which is formed as a switching element for each pixel is disposed close to the crossing point of each set of a gate bus line 12 and a drain bus line 14. A gate electrode of the TFT 21 for driving the nth-row pixel is connected to the gate bus line 12n. In this embodiment, part of the gate bus line 12n functions as a gate electrode of the TFT 21. An operation semiconductor layer (not shown) of the TFT 21 is formed on the gate bus line 12n with an insulating film (gate insulating film) 30 interposed in between, and a channel protective film 21d is formed on the operation semiconductor layer. A drain electrode 21a and an underlying n-type impurity semiconductor layer (not shown) are opposed to a source electrode 21b and an underlying n-type impurity semiconductor layer (not shown) with a prescribed gap on the channel protective film 21d of the TFT 21. The drain electrode 21a of the TFT 21 is electrically connected to the associated drain bus line 14. A protective film 32 (SiN film or the like) is formed over the drain electrode 21a and the source electrode 21b over the entire substrate surface.

A second TFT 22 is disposed in the pixel region at a position close to the top in FIG. 2. A gate electrode 22c of the TFT 22 is electrically connected to the gate bus line 12(n−1) of the preceding stage. An operation semiconductor layer 22e is formed over the gate electrode 22c with the insulating film 30 interposed in between, and a channel protective film 22d is formed on the operation semiconductor layer 22e. A drain electrode 22a and an underlying n-type impurity semiconductor layer 22f are opposed to a source electrode 22b and an underlying n-type impurity semiconductor layer 22f with a prescribed gap on the channel protective film 22d.

Storage capacitor bus lines 18 are formed on the glass substrate 10 so as to traverse the pixel regions and to extend parallel with the gate bus lines 12. FIGS. 2 to 4 show a storage capacitor bus line 18n that is disposed between the gate bus line 12(n−1) and the gate bus line 12n. A storage capacitor electrode 19 is formed for each pixel above the storage capacitor bus line 18 with the insulating film 30 interposed in between. The storage capacitor electrode 19 is electrically connected to the source electrode 21b of the TFT 21 via a connection electrode 25. A storage capacitor Cs is formed between the storage capacitor bus line 18n and the storage capacitor electrode 19 with the insulating film 30 interposed in between.

The pixel region is divided into first sub-pixels A and a second sub-pixel B. The sub-pixel B is disposed at the center of the pixel region and the sub-pixels A are disposed over and under the sub-pixel B in the pixel region (see FIG. 2). A pixel electrode 17 is formed in the sub-pixel B. A pixel electrode 16b which is separated from the pixel electrode 17 is formed in the upper sub-pixel A, and a pixel electrode 16a which is separated from the pixel electrode 17 is formed in the lower sub-pixel A. All of the pixel electrodes 16a, 16b, and 17 are a transparent conductive film made of ITO or the like. To obtain a good viewing angle characteristic, it is desirable that the ratio of the area of the sub-pixel B to the total area of the sub-pixels A be in a range of ½ to 4 (the ratio of the area of the sub-pixel A: sub-pixel B is 2:1 to 1:4). The pixel electrode 16a is electrically connected to the source electrode 21b of the first TFT 21 via a contact hole 50 which is formed through the protective film 32. The pixel electrode 16b is electrically connected, via a contact hole 51 formed through the protective film 32, to a connection electrode 26 which is electrically connected to the source electrode 21b. Part of the pixel electrode 17 coextends with parts of the connection electrodes 25 and 26 and the storage capacitor electrode 19 with the protective film 32 interposed in between. Those parts of the connection electrodes 25 and 26 and the storage capacitor electrode 19 which coextend with the part of the pixel electrode 17 function as a control capacitance electrode, whereby a control capacitance Cc is formed between the pixel electrode 17 and them. In this manner, the pixel electrode 17 is connected indirectly to the source electrode 21b of the TFT 21 via the control (capacitive coupling).

The pixel electrode 16b is electrically connected to the drain electrode (or source electrode) 22a of the second TFT 22 via a contact hole 52 which is formed through the protective film 32. The pixel electrode 17 is electrically connected to the source electrode (or drain electrode) 22b of the TFT 22 via a contact hole 53 which is formed through the protective film 32. That is, the pixel electrodes 16a and 16b are connected to the pixel electrode 17 via the TFT 22.

The opposite substrate 4 has a CF resin layer 40 formed on a glass substrate 11 and a common electrode 42 formed on the CF resin layer 40. A liquid crystal capacitance Clc1 is formed between the pixel electrodes 16a and 16b of the sub-pixels A and the common electrode 42 which are opposed to each other via the liquid crystal 6, and a liquid crystal capacitance Clc2 is formed between the pixel electrode 17 of the sub-pixel B and the common electrode 42 which are opposed to each other via the liquid crystal 6. The liquid crystal capacitance Clc1 is connected in parallel to the storage capacitor Cs. A second storage capacitor that is connected in parallel to the liquid crystal capacitance Clc2 may be formed in such a manner that an electrode that is electrically connected to the storage capacitor bus line 18n overlaps with the pixel electrode 17 with the insulating film 30 and/or the protective film 32 interposed in between. An alignment film (vertical alignment film) 36 is formed at the interface between the TFT substrate 2 and the liquid crystal 6 and an alignment film 37 is formed at the interface between the opposite substrate 4 and the liquid crystal 6, whereby liquid crystal molecules of the liquid crystal 6 are aligned almost perpendicularly to the substrate surfaces when no voltage is applied.

The reason why a relatively high degree of burn-in occurs in the conventional liquid crystal display device employing the capacitive coupling HT technique is that charge accumulated in the pixel electrode 117 of the sub-pixel B is not released easily because the pixel electrode 117 is connected to each of the control capacitance electrode 125 and the common electrode 142 via a very high electrical resistance. In contrast, in this embodiment, the pixel electrode 17 of the sub-pixel B is connected to the pixel electrodes 16a and 16b and the source electrode 21b of the TFT 21 via the TFT 22. The electrical resistance of the operation semiconductor layer 22e of the TFT 22 is much lower than that of each of the insulating film 30, the protective film 32, the liquid crystal layer, etc. even in an off state. In addition, since the gate electrode 22c of the TFT 22 is electrically connected to the gate bus line 12(n−1) of the preceding stage, the TFT 22 is turned on immediately before the TFT 21 is turned on and a prescribed voltage is applied to the pixel electrodes 16a, 16b, and 17, whereby the electrical resistance between the pixel electrode 17 and each of the pixel electrodes 16a and 16b is further reduced. Therefore, charge accumulated in the pixel electrode 17 is released easily. As a result, according to this embodiment, a high degree of burn-in does not occur though the capacitive coupling HT technique is employed.

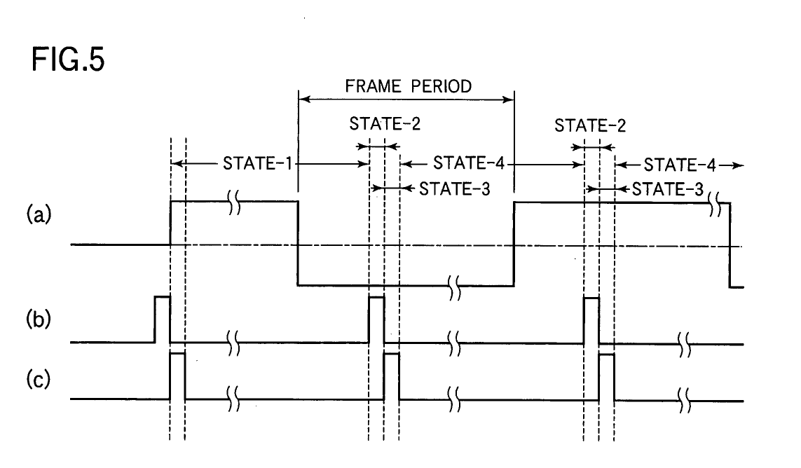

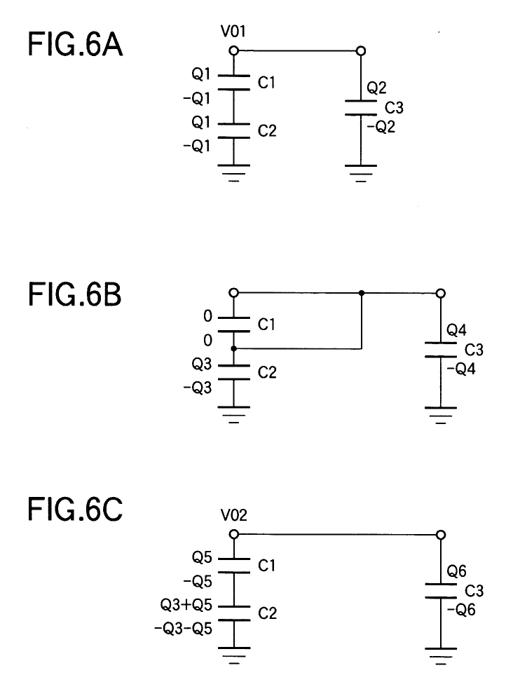

Next, the operation of the liquid crystal display device according to the embodiment will be described. FIG. 5 shows drive waveforms used in the liquid crystal display device according to the embodiment. FIG. 5(a) shows the waveform of a data voltage that is applied to the drain bus line 14 which is connected to the drain electrode 21a of the TFT 21 for the nth-row pixel. FIG. 5(b) shows the waveform of a gate voltage that is applied to the (n−1)th gate bus line 12(n−1) which is connected to the gate electrode 22c of the TFT 22 for the pixel concerned. FIG. 5(c) shows the waveform of a gate voltage that is applied to the nth gate bus line 12n which is connected to the gate electrode of the TFT 21 for the pixel concerned. The horizontal axes of FIG. 5 represent time (about three frames are covered) and the vertical axes represent the voltage. FIGS. 6A to 6C illustrate how the TFT 22 for the pixel concerned operates and the voltages of the individual capacitors vary. It is assumed that the control capacitance Cc has a capacitance C1, the liquid crystal capacitance Clc2 of the sub-pixel B (in the configuration having the second storage capacitor, the liquid crystal capacitance Clc2 plus the second storage capacitor) has a capacitance C2, and the liquid crystal capacitance Clc1 of the sub-pixels A plus the storage capacitor Cs have a capacitance C3 (C1-C3 will also denote capacitors). In the initial state, the voltages across the liquid crystal capacitances Clc1 and Clc2 of the pixel concerned are 0 and hence the pixel concerned displays black.

FIG. 6A corresponds to state-1 shown in FIG. 5. In state-1, an on-voltage is applied to the gate bus line 12n and the TFT 21 which is connected to the gate bus line 12n is turned on, whereby a prescribed voltage V01 is applied to the pixel electrodes 16a and 16b of the pixel that has been in the initial state. Let V11, V21, and V31 represent voltages across the capacitances C1, C2, and C3, respectively; then, charge Q1 stored in each of the capacitances C1 and C2 that are connected to each other in series is given by Q1=C1×V11=C2×V21 and charge Q2 stored in the capacitance C3 is given by Q2=C3×V31. Since V11+V21=V31=V01, in state-1 the voltage V11 across the capacitance C1 (control capacitance Cc) and the voltage V21 across the capacitance C2 (liquid crystal capacitance Clc2 of the sub-pixel B) are given by
V11={C2/(C1+C2)}×V01
V21={C1/(C1+C2)}×V01.
State-1 is maintained for about a 1-frame time until an on-voltage is applied to the gate bus line 12(n−1) of the preceding stage in the next frame.

Then, an on-voltage is applied to the gate bus line 12(n−1) of the preceding stage, whereupon state-2 is established. FIG. 6B corresponds to state-2 shown in FIG. 5. In state-2, the TFT 21 is off and the TFT 22 is on. Since the TFT 22 is on, as shown in FIG. 6B the control capacitance electrodes (connection electrodes 25 and 26 and storage capacitor electrode 19) and the pixel electrode 17 that form the capacitance C1 (control capacitance Cc) have the same potential and the pixel electrodes 16a and 16b of the sub-pixels A and the pixel electrode 17 of the sub-pixel B also have the same potential. Therefore, the voltage across the capacitance C1 becomes 0 and the charge stored in the capacitance C1 also becomes 0. Part of the charge that has been stored in the pixel electrode 17 of the sub-pixel B moves to the pixel electrodes 16a and 16b of the sub-pixels A. Let V22 and V32 represent voltages across the capacitances C2 and C3, respectively; then, charge Q3 stored in the capacitance C2 is given by Q3=C2×V22 and charge Q4 stored in the capacitance C3 is given by Q4=C3×V32. Since the voltages V22 and V32 are identical, a relationship
Q3/C2=Q4/C3
holds. The law of charge conservation requires that Q3+Q4=Q1+Q2, in state-2 the voltage V22 across the capacitance C2 (liquid crystal capacitance Clc2 of the sub-pixel B) is given by
V22={1/(C2+C3)}×(C2×V21+C3×V31).

Then, an on-voltage is applied to the gate bus line 12n approximately at the same time as an off-voltage is applied to the gate bus line 12(n−1), whereupon state-3 is established. FIG. 6C corresponds to state-3 shown in FIG. 5. In state-3, the TFT 21 is on and the TFT 22 is off. Since the TFT 21 is on, a new voltage V02 is applied to the pixel electrodes 16a and 16b. Let V13, V23, and V33 represent voltages of the capacitances C1, C2, and C3, respectively; then, as shown in FIG. 6C charge Q5 stored in the capacitance C1 is given by Q5=C1×V13 and charge (Q3+Q5) stored in the capacitance C2 is given by (Q3+Q5)=C2×V23, and charge Q6 stored in the capacitance C3 is given by Q6=C3×V33. Since V13+V23=V33=V02, in state-3 the voltage V13 across capacitance C1 (control capacitance Cc) and the voltage V23 across the capacitance C2 (liquid crystal capacitance Clc2 of the sub-pixel B) are given by
V13=(V02−V22)×C2/(C1+C2)
V23=V02−V13.

Then, an off-voltage is applied to the gate bus line 12n, whereupon state-4 is established. In state-4, both of the TFTs 21 and 22 are off. State-4 is maintained for about a 1-frame time until an on-voltage is applied to the gate bus line 12(n−1) of the preceding stage in the next frame, and the voltages of the capacitances C1, C2, and C3 are held as they are during that period. From this time onward, state-2, state-3, and state-4 occur in this order cyclically as the frame is updated.

The pixel electrodes 16a and 16b of the sub-pixels A are connected to the drain bus line 14 via the TFT 21. The electrical resistance of the TFT 21 is relatively low even in an off state and is even lower in an on state. Since in general the voltage applied to the drain bus line 14 is reversed in polarity every frame, no charge builds up in the pixel electrode 16a or 16b. Further, the pixel electrode 17 of the sub-pixel B is connected to the pixel electrodes 16a and 16b via the TFT 22 whose electrical resistance is relatively low like the TFT 21's. Therefore, no charge builds up in the pixel electrode 17.

In the liquid crystal display device employing the capacitive coupling HT technique, it is known that a good viewing angle characteristic is obtained when the voltage ratio Vpx2/Vpx1 of the voltage Vpx2 that is applied to the portion of the liquid crystal layer corresponding to the sub-pixel B to the voltage Vpx1 that is applied to the portion of the liquid crystal layer corresponding to the sub-pixel A is in a range of about 0.6 to 0.85 and that a particularly good viewing angle characteristic is obtained when the voltage ratio Vpx2/Vpx1 is equal to about 0.72. In the configuration employing the capacitive coupling HT technique, the relationship Vpx2/Vpx1=Cc/(Clc2+Cc) holds. Therefore, a voltage ratio Vpx2/Vpx1 being equal to about 0.72 is obtained by setting the capacitance ratio Cc/Clc2 at 2.5. Based on the above discussion, in the liquid crystal display device having a configuration shown in FIGS. 2 and 3, the pixel was designed by adjusting the area of the control capacitance electrode, the thickness of the protective film 32, and other factors so that the capacitance ratio Cc/Clc2 became equal to 2.5.

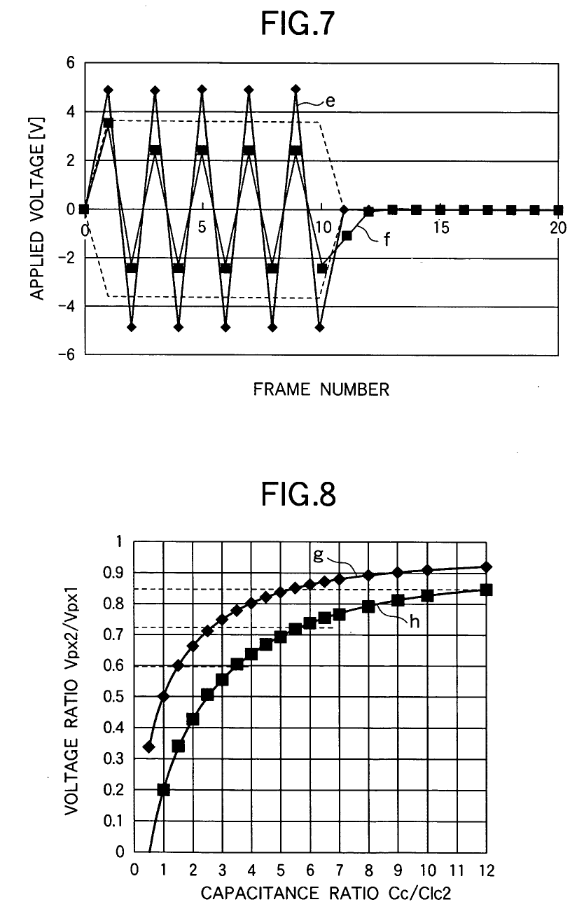

FIG. 7 is a graph showing voltage variations of the pixel electrodes 16a, 16b, and 17 of the above liquid crystal display device in a case that a voltage 0 V is applied to the pixel electrodes 16a and 16b to display black in a 0th frame, voltages +5 V are applied to the pixel electrodes 16a and 16b to display white in first to 10th frames, and a voltage 0 V is applied to the pixel electrodes 16a and 16b to display black in 11th to 20th frames. In the graph, the horizontal axis represents the frame number and the vertical axis represents the application voltage (V). Line e represents the voltage Vpx1 which is applied to the pixel electrodes 16a and 16b, and line f represents the voltage Vpx2 which is applied to the pixel electrode 17. Broken lines in the graph are lines obtained by connecting points having voltages that are equal to 0.72 times the voltage Vpx1 on the positive side and the negative side. As shown in FIG. 7, in the first frame, since the voltage Vpx1 varies by +5 V (0 V→+5 V), the voltage Vpx2 varies by about +3.5 V which is 0.72 times +5 V (0 V→+3.5 V).

The TFT 22 is turned on immediately before the start of the second frame, whereupon the pixel electrodes 16a, 16b, and 17 are given the same potential and both of the voltages Vpx1 and Vpx2 become about +4 V. In the second frame, the data voltage is written, whereby the voltage Vpx1 becomes −5 V. That is, the voltage Vpx1 varies by −9 V. The voltage Vpx2 varies by about −6.5 V which is 0.72 times −9 V, and thereby becomes about −2.5 V.

The TFT 22 is turned on immediately before the start of the third frame, whereupon the pixel electrodes 16a, 16b, and 17 are given the same potential and both of the voltages Vpx1 and Vpx2 become about −3.5 V. In the third frame, the data voltage is written, whereby the voltage Vpx1 becomes +5 V. That is, the voltage Vpx1 varies by +8.5 V. The voltage Vpx2 varies by about +6 V which is 0.72 times +8.5 V, and thereby becomes about +2.5 V. In the fourth to 10th frames, the voltages vary in the same manner as in the third frame except that the polarity of the voltages is reversed every frame. The voltage Vpx1 becomes +5 V and the voltage Vpx2 becomes about +2.5 V.

The TFT 22 is turned on immediately before the start of the 11th frame, whereupon the pixel electrodes 16a, 16b, and 17 are given the same potential and both of the voltages Vpx1 and Vpx2 become about −3.5 V. In the 11th frame, the data voltage is written, whereby the voltage Vpx1 becomes 0 V. That is, the voltage Vpx1 varies by −3.5 V. The voltage Vpx2 varies by about −2.5 V which is 0.72 times −3.5 V, and thereby becomes about −1 V. In the 12th and following frames, both of the voltages Vpx1 and Vpx2 are made equal to about 0 V.

The voltage Vpx2 which is applied to the pixel electrode 17 of the sub-pixel B of the above liquid crystal display device has the following two features.

The first feature is that in the second to 10th frames the voltages Vpx1 and Vpx2 are about +5 V and about +2.5 V, respectively, and hence the voltage ratio Vpx2/Vpx1 is equal to about 0.5. This value is smaller than the voltage ratio Vpx2/Vpx1 (=0.72) that is calculated according to the relationship Vpx2/Vpx1=Cc/(Clc2+Cc). This liquid crystal display device cannot provide an improved viewing angle characteristic because the range of the voltage ratio Vpx2/Vpx1 in which a good viewing angle characteristic is obtained is approximately 0.6 to 0.85.

FIG. 8 is a graph showing how the voltage ratio Vpx2/Vpx1 varies as the capacitance ratio Cc/Clc2 is varied. The horizontal axis represents the capacitance ratio Cc/Clc2 and the vertical axis represents the voltage ratio Vpx2/Vpx1. Line g represents the voltage ratio of the conventional liquid crystal display device that is obtained according to the relationship Vpx2/Vpx1=Cc/(Clc2+Cc), and line h represents the voltage ratio of the liquid crystal display device according to the embodiment. As shown in FIG. 8, in the conventional liquid crystal display device, the voltage ratio Vpx2/Vpx1 approximately falls within the range of 0.6 to 0.85 and a good viewing angle characteristic is obtained by setting the capacitance ratio Cc/Clc2 approximately in a range of 1.5 to 5.5. In contrast, in the liquid crystal display device according to the embodiment, for the voltage ratio Vpx2/Vpx1 to fall within the range of 0.6 to 0.85, it is necessary to set the capacitance ratio Cc/Clc2 in a range of 3.5 to 12. Whereas in the conventional configuration the voltage ratio Vpx2/Vpx1 (=0.72) at which a particularly good viewing angle characteristic is obtained, is obtained by setting the capacitance ratio Cc/Clc2 at 2.5, in this embodiment it is obtained by setting the capacitance ratio Cc/Clc2 at about 6. That is, it has been found that in this embodiment the range of the capacitance ratio Cc/Clc2 in which a good viewing angle characteristic is obtained is shifted very much from the corresponding range of the conventional configuration and hence a desired voltage ratio Vpx2/Vpx1 cannot be obtained as long as the conventional theory is followed. It has also been found that a good viewing angle characteristic is obtained by setting the capacitance ratio Cc/Clc2 in a range of 3.5 to 12 (preferably at about 6).

The second feature is that the voltage Vpx2 of the sub-pixel B in the first frame is higher than the absolute values of that in the second to 10th frames. That is, only in the first frame the voltage ratio Vpx2/Vpx1 is approximately equal to the value (=0.72) obtained according to the relationship Vpx2/Vpx1=Cc/(Clc2+Cc). If the capacitance ratio Cc/Clc2 is set at 6 as described above, the voltage ratio Vpx2/Vpx1 becomes larger than 0.72 in the first frame though it becomes approximately equal to 0.72 in the second to 10th frames.

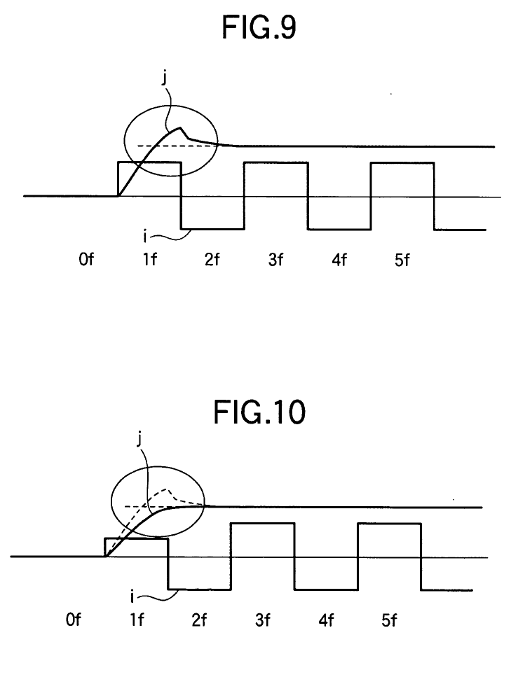

FIG. 9 is a graph showing how the voltage Vpx1 and the luminance of the entire pixel vary over time in the first to fifth frames. The horizontal axis represents time and the vertical axis represents the voltage or luminance. Line i represents the voltage Vpx1 and line j represents the luminance. If an overshoot occurs in the voltage Vpx2 in the first frame, the luminance of the sub-pixel B becomes too high in the first frame provided that the response speed of the liquid crystal is sufficiently high. As a result, the luminance of the entire pixel also becomes too high, that is, becomes higher than a desired luminance level only in the first frame (1f; enclosed by an ellipse in FIG. 9). More specifically, a phenomenon may occur that edges are emphasized too much when a moving image is displayed.

FIG. 10 is a graph showing how the voltage Vpx1 and the luminance of the entire pixel vary over time in the case where a driving method of a liquid crystal display device according to the embodiment is used. For example, a control section of the liquid crystal display device according to the embodiment compares, on a pixel-by-pixel basis, input gradation data of two frames (input gradation data Gm of an mth frame and input gradation data G(m+1) of an (m+1)th frame) stored in frame memories. If Gm<G(m+1) (in this example, m=0), underdrive-type driving is performed as shown in FIG. 10 in which a correction is made so that actually-output output gradation data G′(m+1) of the (m+1)th frame satisfies a relationship Gm<G′(m+1)<G(m+1) and a voltage that is lower than the original value is applied to the liquid crystal layer in the (m+1)th frame. As a result, a desired luminance level can be obtained in the first frame (enclosed by an ellipse in FIG. 10). On the other hand, although not shown in any drawing, if Gm>G(m+1) (in this example, m=10), overdrive-type driving is performed in which a correction is made so that actually-output output gradation data G′(m+1) of the (m+1)th frame satisfies a relationship Gm>G′(m+1)>G(m+1) and a voltage that is higher than the original value is applied to the liquid crystal layer in the (m+1)th frame.

The above-described two features are absent in the conventional liquid crystal display device employing the capacitive coupling HT technique; that is, they are phenomena that have been newly found in the liquid crystal display device according to this embodiment. Therefore, the manner of setting a capacitance ratio Cc/Clc2 and the driving method of a liquid crystal display device that are employed to solve the problems resulting from the above features are new techniques that are disclosed in this embodiment for the first time.

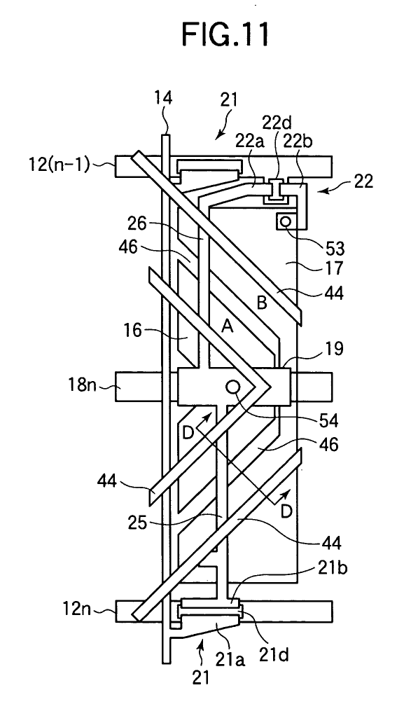

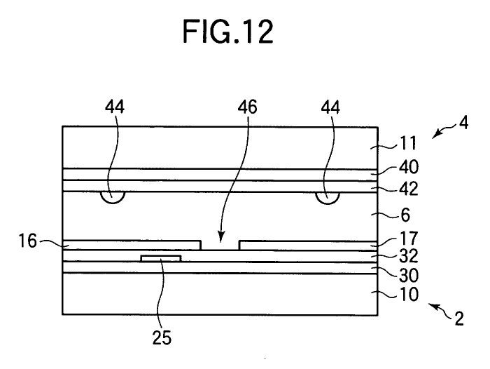

FIG. 11 shows a one-pixel configuration in which this embodiment is applied to an MVA (multi-domain vertical alignment)-type liquid crystal display device. FIG. 12 is a sectional view of the liquid crystal display device taken along line D-D in FIG. 11. As shown in FIGS. 11 and 12, linear protrusions 44 which extend obliquely with respect to the end lines of the pixel region are provided in the opposite substrate 4 as alignment restriction structures for restricting the alignment of the liquid crystal. The linear protrusions 44 are made of a photosensitive resin or the like. Instead of the linear protrusions 44, slits may be formed in the common electrode 42 as alignment restriction structures. The pixel region is divided into sub-pixels A and B. A pixel electrode 16 is formed in the sub-pixel A, and a pixel electrode 17 which is separated from the pixel electrode 16 is formed in the sub-pixel B. A linear slit 46 which separates the pixel electrodes 16 and 17 from each other extends obliquely with respect to the end lines of the pixel region so as to be parallel with the linear protrusions 44. The slit 46 also functions as an alignment restriction structure on the TFT substrate 2 side.

A liquid crystal display device having the configuration shown in FIGS. 11 and 12 was manufactured by adjusting the area of the control capacitance electrode, the thickness of the protective film 32, and other factors so that the capacitance ratio Cc/Clc2 became equal to about 6. A burn-in test was performed by displaying a black-and-white checkered pattern on the display screen of this liquid crystal display device continuously for 48 hours under a temperature condition of 50° C. It was confirmed that no burn-in occurs at all in this liquid crystal display device unlike in the conventional liquid crystal display device employing the capacitive coupling HT technique.

In general, because of the occurrence of a burn-in phenomenon, it is difficult to put conventional liquid crystal display devices employing the capacitive coupling HT technique into practical use though they exhibit a very good viewing angle characteristic. In contrast, the configuration of this embodiment is different from the conventional configuration in that none of the pixel electrodes 16 (16a and 16b) of the sub-pixels A and the pixel electrode 17 of the sub-pixel B are in a floating state. The pixel electrodes 16 are connected to the drain bus line 14 via the TFT 21 and the pixel electrode 17 is connected to the pixel electrodes 16 via the TFT 22. Therefore, no burn-in occurs and a liquid crystal display device exhibiting a good viewing angle characteristic can be obtained. Further, better display characteristics can be obtained by setting the capacitance ratio Cc/Clc2 in the range that is different from the conventional range and optimizing the driving method of a liquid crystal display device in consideration of the phenomena that have been newly found in the liquid crystal display device according to this embodiment.

### Second Embodiment

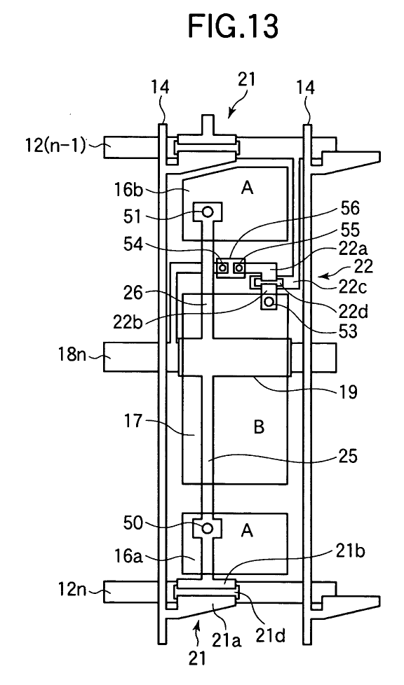

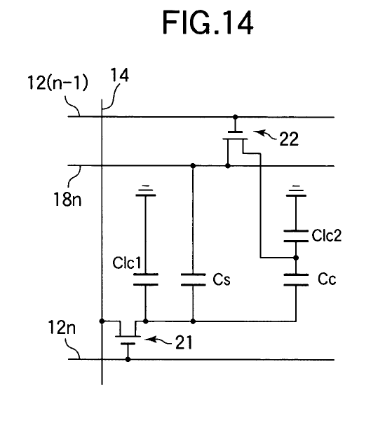

Next, a substrate for a liquid crystal display device, a liquid crystal display device having it, and a driving method of a liquid crystal display device according to a second embodiment of the invention will be hereinafter described with reference to FIGS. 13 to 21. FIG. 13 shows the configuration of one nth-row pixel of a substrate for a liquid crystal display device according to the embodiment. FIG. 14 shows an equivalent circuit of the one nth-row pixel of the liquid crystal display device according to the embodiment. As shown in FIGS. 13 and 14, this embodiment is characterized in that the storage capacitor bus line 18n is connected to the pixel electrode 17 of the sub-pixel B via a second TFT 22. A drain electrode (or source electrode) 22a of the TFT 22 is electrically connected to a link electrode 56 which is made of the same material and in the same layer as the pixel electrodes 16a, 16b, and 17 via a contact hole 55 which is formed through the protective film 32. The link electrode 56 is electrically connected to the storage capacitor bus line 18n via a contact hole 54 which is formed through the protective film 32 and the insulating film 30. A source electrode (or drain electrode) 22b of the TFT 22 is electrically connected to the pixel electrode 17 via a contact hole 53 which is formed through the protective film 32, and its gate electrode 22c is electrically connected to the gate bus line 12(n−1) of the preceding stage. A second storage capacitor that is connected in parallel to the liquid crystal capacitance Clc2 may be formed in such a manner that an electrode that is electrically connected to the storage capacitor bus line 18n overlaps with the pixel electrode 17 with the insulating film 30 and/or the protective film 32 interposed in between.

In this embodiment, the pixel electrode 17 of the sub-pixel B is connected to the storage capacitor bus line 18n via the TFT 22. The electrical resistance of the operation semiconductor layer of the TFT 22 is much lower than that of each of the insulating film 30, the protective film 32, the liquid crystal layer, etc. even in an off state. In addition, since the gate electrode 22c of the TFT 22 is electrically connected to the gate bus line 12(n−1) of the preceding stage, the TFT 22 is turned on immediately before the TFT 21 is turned on and a prescribed voltage is applied to the pixel electrodes 16a, 16b, and 17, whereby the electrical resistance between the pixel electrode 17 and the storage capacitor bus line 18n is further reduced. Therefore, charge accumulated in the pixel electrode 17 is released easily. Since the storage capacitor bus line 18n is at the same potential as the common electrode 42, charge accumulated in the pixel electrode 17 is released easily even if it is of a large amount. As a result, according to this embodiment, a high degree of burn-in does not occur though the capacitive coupling HT technique is employed.

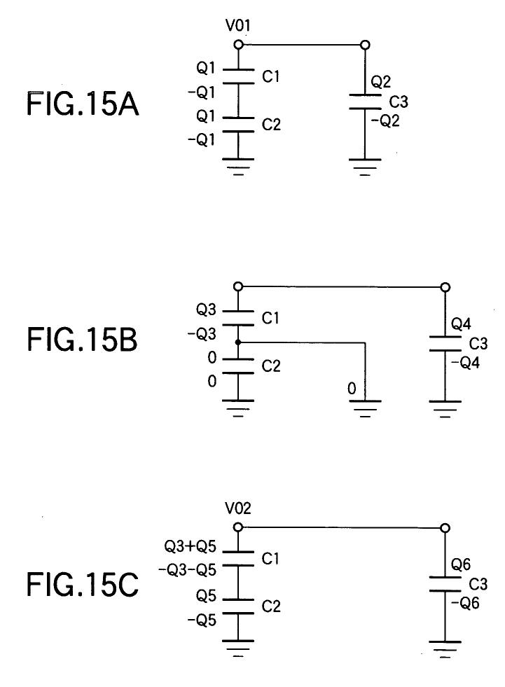

Next, the operation of the liquid crystal display device according to the embodiment will be described. FIGS. 15A to 15C illustrate how the TFT 22 operates and the voltages of the individual capacitors vary when the liquid crystal display device is driven in the manner shown in FIG. 5. It is assumed that the control capacitance Cc has a capacitance C1, the liquid crystal capacitance Clc2 of the sub-pixel B (in the configuration having the second storage capacitor, the liquid crystal capacitance Clc2 plus the second storage capacitor) has a capacitance C2, and the liquid crystal capacitance Clc1 of the sub-pixels A plus the storage capacitor Cs have a capacitance C3 (C1-C3 will also denote capacitances). In the initial state, the voltages across the liquid crystal capacitances Clc1 and Clc2 of the pixel concerned are 0 and hence the pixel concerned displays black.

FIG. 15A corresponds to state-1 shown in FIG. 5. In state-1, an on-voltage is applied to the gate bus line 12n and the TFT 21 which is connected to the gate bus line 12n is turned on, whereby a prescribed voltage V01 is applied to the pixel electrodes 16a and 16b of the pixel that has been in the initial state. Let V11, V21, and V31 represent voltages across the capacitances C1, C2, and C3, respectively; then, charge Q1 stored in each of the capacitances C1 and C2 that are connected to each other in series is given by Q1=C1×V11=C2×V21 and charge Q2 stored in the capacitance C3 is given by Q2=C3×V31. Since V11+V21=V31=V01, in state-1 the voltage V11 across the capacitance C1 (control capacitance Cc) and the voltage V21 across the capacitance C2 (liquid crystal capacitance Clc2 of the sub-pixel B) are given by
V11={C2/(C1+C2)}×V01
V21={C1/(C1+C2)}×V01.
State-1 is maintained for about a 1-frame time until an on-voltage is applied to the gate bus line 12(n−1) of the preceding stage in the next frame.

Then, an on-voltage is applied to the gate bus line 12(n−1) of the preceding stage, whereupon state-2 is established. FIG. 15B corresponds to state-2 shown in FIG. 5. In state-2, the TFT 21 is off and the TFT 22 is on. Since the TFT 22 is on, as shown in FIG. 15B the pixel electrode 17 and the common electrode 42 that form the capacitance C2 (liquid crystal capacitance Clc2 of the sub-pixel B) have the same potential. Therefore, the voltage across the capacitance C2 becomes 0 and the charge stored in the capacitance C2 also becomes 0. Part of the charge that has been stored in the control capacitance electrodes which forms the capacitance C1 (connection electrodes 25 and 26 and storage capacitor electrode 19) moves to the pixel electrodes 16a and 16b of the sub-pixels A. Let V12 and V32 represent voltages across the capacitances C1 and C3, respectively; then, charge Q3 stored in the capacitance C1 is given by Q3=C1×V12 and charge Q4 stored in the capacitance C3 is given by Q4=C3×V32. Since the voltages V12 and V32 are identical, a relationship
Q3/C1=Q4/C3
holds. The law of charge conservation requires that Q3+Q4=Q1+Q2, in state-2 the voltage V12 across the capacitance C1 (control capacitance Cc) is given by
V12={1/(C1+C3)}×(C1×V11+C3×V31).

Then, an on-voltage is applied to the gate bus line 12n approximately at the same time as an off-voltage is applied to the gate bus line 12(n−1), whereupon state-3 is established. FIG. 15C corresponds to state-3 shown in FIG. 5. In state-3, the TFT 21 is on and the TFT 22 is off. Since the TFT 21 is on, a new voltage V02 is applied to the pixel electrodes 16a and 16b. Let V13, V23, and V33 represent voltages of the capacitances C1, C2, and C3, respectively; then, as shown in FIG. 15C charge (Q3+Q5) stored in the capacitance C1 is given by (Q3+Q5)=C1×V13 and charge Q5 stored in the capacitance C2 is given by Q5=C2×V23, and charge Q6 stored in the capacitance C3 is given by Q6=C3×V33. Since V13+V23=V33=V02, in state-3 the voltage V23 across capacitance C2 (liquid crystal capacitance Clc2 of the sub-pixel B) and the voltage V13 across the capacitance C1 (control capacitance Cc) are given by
V23=(V02−V12)×C1/(C1+C2)
V13=V02−V23.

Then, an off-voltage is applied to the gate bus line 12n, whereupon state-4 is established. In state-4, both of the TFTs 21 and 22 are off. State-4 is maintained for about a 1-frame time until an on-voltage is applied to the gate bus line 12(n−1) of the preceding stage in the next frame, and the voltages of the capacitances C1, C2, and C3 are held as they are during that period. From this time onward, state-2, state-3, and state-4 occur in this order cyclically as the frame is updated.

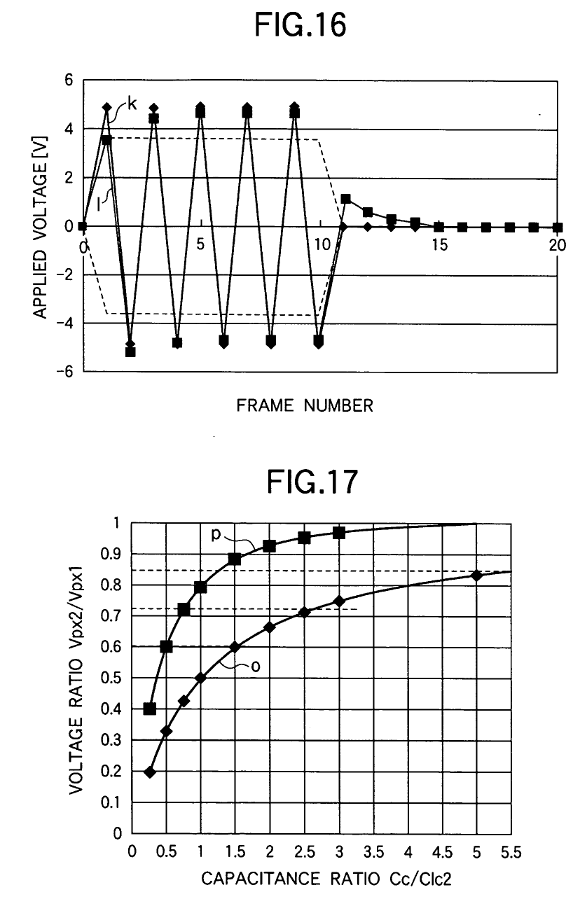

Also in this embodiment, a liquid crystal display device was manufactured in which to realize a voltage ratio Vpx2/Vpx1 being equal to about 0.72 the pixel was designed according to the conventional theory so that the capacitance ratio Cc/Clc2 is made equal to 2.5. FIG. 16 is a graph showing voltage variations of the pixel electrodes 16a, 16b, and 17 of the thus-manufactured liquid crystal display device in a case that a voltage 0 V is applied to the pixel electrodes 16a and 16b to display black in a 0th frame, voltages +5 V are applied to the pixel electrodes 16a and 16b to display white in first to 10th frames, and a voltage 0 V is applied to the pixel electrodes 16a and 16b to display black in 11th to 20th frames. In the graph, the horizontal axis represents the frame number and the vertical axis represents the application voltage (V). Line k represents the voltage Vpx1 which is applied to the pixel electrodes 16a and 16b, and line 1 represents the voltage Vpx2 which is applied to the pixel electrode 17. Broken lines in the graph are lines obtained by connecting points having voltages that are equal to 0.72 times the voltage Vpx1 on the positive side and the negative side.

As shown in FIG. 16, the voltage Vpx2 which is applied to the pixel electrode 17 of the sub-pixel B of the above liquid crystal display device has the following two features.

The first feature is that in the second to 10th frames the voltages Vpx1 and Vpx2 are about +5 V and about +4.75 V, respectively, and hence the voltage ratio Vpx2/Vpx1 is equal to about 0.95. This value is larger than the voltage ratio Vpx2/Vpx1 (=0.72) that is calculated according to the relationship Vpx2/Vpx1=Cc/(Clc2+Cc). This liquid crystal display device cannot provide an improved viewing angle characteristic because the range of the voltage ratio Vpx2/Vpx1 in which a good viewing angle characteristic is obtained is approximately 0.6 to 0.85.

In the above liquid crystal display device, the DC component of the application voltage is relatively large because of the presence of the parallel capacitor. Because of this phenomenon, a state that the absolute value of the voltage Vpx2 becomes larger than that of the voltage Vpx1 occurs as exemplified by the voltage relationship in the second frame in FIG. 16. The DC component of the application voltage becomes approximately equal to 0 in about an 8-frame time, that is, earlier than in the case that no parallel capacitor exists. The DC component of the application voltage influences the response speed of the liquid crystal and may cause an instantaneous flicker.

FIG. 17 is a graph showing how the voltage ratio Vpx2/Vpx1 varies as the capacitance ratio Cc/Clc2 is varied. The horizontal axis represents the capacitance ratio Cc/Clc2 and the vertical axis represents the voltage ratio Vpx2/Vpx1. Line o represents the voltage ratio of the conventional liquid crystal display device that is obtained according to the relationship Vpx2/Vpx1=Cc/(Clc2+Cc), and line p represents the voltage ratio of the liquid crystal display device according to this embodiment. As shown in FIG. 17, in the conventional liquid crystal display device, the voltage ratio Vpx2/Vpx1 approximately falls within the range of 0.6 to 0.85 and a good viewing angle characteristic is obtained by setting the capacitance ratio Cc/Clc2 approximately in a range of 1.5 to 5.5. In contrast, in the liquid crystal display device according to the embodiment, for the voltage ratio Vpx2/Vpx1 to fall within the range of 0.6 to 0.85, it is necessary to set the capacitance ratio Cc/Clc2 in a range of 0.5 to 1.3. Whereas in the conventional configuration the voltage ratio Vpx2/Vpx1 (=0.72) at which a particularly good viewing angle characteristic is obtained is obtained by setting the capacitance ratio Cc/Clc2 at 2.5, in this embodiment it is obtained by setting the capacitance ratio Cc/Clc2 at about 0.75. That is, it has been found that in this embodiment the range of the capacitance ratio Cc/Clc2 in which a good viewing angle characteristic is obtained is shifted very much from the corresponding range of the conventional configuration and hence a desired voltage ratio Vpx2/Vpx1 cannot be obtained as long as the conventional theory is followed. It has also been found that a good viewing angle characteristic is obtained by setting the capacitance ratio Cc/Clc2 in a range of 0.5 to 1.3 (preferably at about 0.75).

The second feature is that the voltage Vpx2 in the first frame is lower the absolute values of that in the second to 10th frames. That is, only in the first frame the voltage ratio Vpx2/Vpx1 is approximately equal to the value (=0.72) obtained according to the relationship Vpx2/Vpx1=Cc/(Clc2+Cc).

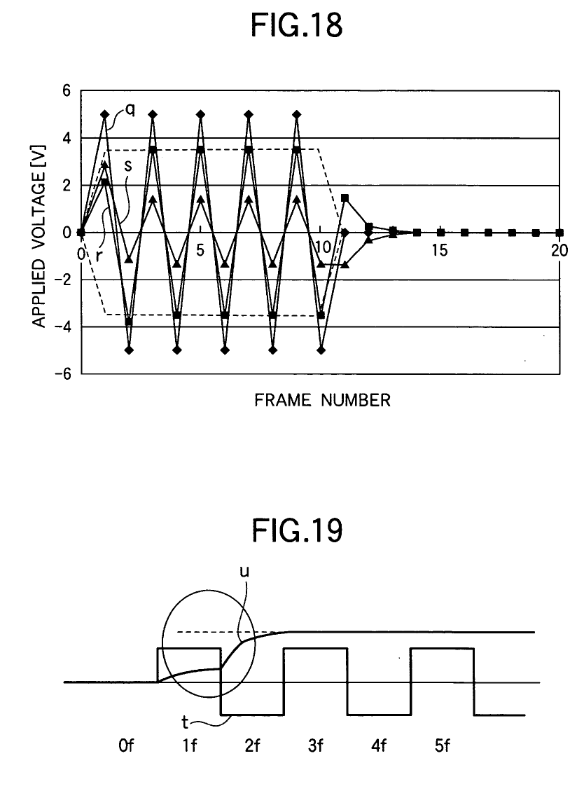

FIG. 18 is a graph showing voltage variations of the pixel electrodes 16a, 16b, and 17 in the case where the capacitance ratio Cc/Clc2 is set at 0.75. The horizontal axis and the vertical axis represent the same things as in FIG. 16. Line q represents the voltage Vpx1 which is applied to the pixel electrodes 16a and 16b, line r represents the voltage Vpx2 which is applied to the pixel electrode 17, and line s represents the voltage difference Vpx1−Vpx2. As shown in FIG. 18, where the capacitance ratio Cc/Clc2 is set at 0.75, the voltage ratio Vpx2/Vpx1 is approximately equal to 0.72 in the second to 10th frames but is smaller than 0.72 in the first frame. The DC component of the application voltage becomes approximately equal to 0 in about a 4-frame time, that is, earlier than in the case where the capacitance ratio Cc/Clc2 is set at 2.5 (in about an 8-frame time).

FIG. 19 is a graph showing how the voltage Vpx1 applied to the pixel electrodes 16a and 16b of the pixel concerned and the luminance of the entire pixel vary over time in the first to fifth frames in the case where the capacitance ratio Cc/Clc2 is set at 0.75. The horizontal axis represents time and the vertical axis represents the voltage or luminance. Line t represents the voltage Vpx1 and line u represents the luminance. As shown in FIG. 19, the luminance of the entire pixel does not reach a desired value in the first frame (1f) because of low luminance of the sub-pixel B even if the response speed of the liquid crystal is sufficiently high. Two frames, for example, are needed for the luminance of the entire pixel to reach the desired value. This results in a two-step response in which the luminance variation waveform has two steps (enclosed by an ellipse in FIG. 19). More specifically, a phenomenon may occur that edges are blurred when a moving image is displayed.

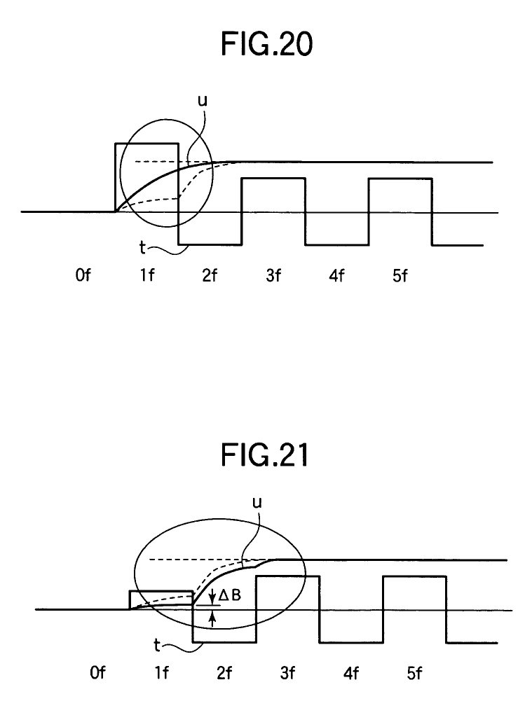

FIG. 20 is a graph showing how the voltage Vpx1 and the luminance of the entire pixel vary over time in the case where a driving method of a liquid crystal display device according to the embodiment is used. For example, a control section of the liquid crystal display device according to the embodiment compares, on a pixel-by-pixel basis, input gradation data of two frames (input gradation data Gm of an mth frame and input gradation data G(m+1) of an (m+1)th frame) stored in frame memories. If Gm<G(m+1) (in this example, m=0), overdrive-type driving is performed as shown in FIG. 20 in which a correction is made so that actually-output output gradation data G′(m+1) of the (m+1)th frame satisfies a relationship G′(m+1)>G(m+1) and a voltage that is higher than the original value is applied to the liquid crystal layer in the (m+1)th frame. As a result, a desired luminance level can be obtained in the first frame (enclosed by an ellipse in FIG. 20). On the other hand, although not shown in any drawing, if Gm>G(m+1) (in this example, m=10), underdrive-type driving is performed in which a correction is made so that actually-output output gradation data G′(m+1) of the (m+1)th frame satisfies a relationship G′(m+1)≦G(m+1) and a voltage that is lower than the original value is applied to the liquid crystal layer in the (m+1)th frame.

FIG. 21 is a graph showing how the voltage Vpx1 and the luminance of the entire pixel vary over time in the case where another driving method of a liquid crystal display device according to the embodiment is used. As shown in FIG. 21, in this example, if Gm<G(m+1), underdrive-type driving is performed in which a correction is made so that actually-output output gradation data G′(m+1) of the (m+1)th frame satisfies a relationship Gm<G′(m+1)<G(m+1) and a voltage that is lower than the original value is applied to the liquid crystal layer in the (m+1)th frame. Let Bm represent pixel luminance that is obtained on the basis of the input gradation data Gm (in FIG. 21, luminance in the 0th frame), and let B(m+1) represent pixel luminance that is obtained on the basis of the input gradation data G(m+1) (in FIG. 21, luminance in the 4th and following frames). The correction is made so that a luminance variation ΔB in the (m+1)th frame becomes less than or equal to 10% of a luminance difference B(m+1)−Bm (i.e., ΔB≦(B(m+1)−Bm)×0.1). As a result, a three-step response is caused in which the luminance variation waveform has three steps (enclosed by an ellipse in FIG. 21). Intentionally applying a lower voltage in the (m+1)th frame in this manner increases the luminance variation in the (m+2)th frame though the response speed of the liquid crystal is substantially lowered by one frame. As a result, for example, blurring of edges of a moving image due to a slow response speed of the liquid crystal is made less visually recognizable.

The above-described two features are absent in the conventional liquid crystal display device employing the capacitive coupling HT technique; that is, they are phenomena that have been newly found in the liquid crystal display device according to this embodiment. Therefore, the manner of setting a capacitance ratio Cc/Clc2 and the driving method of a liquid crystal display device that are employed to solve the problems resulting from the above features are new techniques that are disclosed in this embodiment for the first time.

In this embodiment, none of the pixel electrodes 16a and 16b of the sub-pixels A and the pixel electrode 17 of the sub-pixel B are in a floating state. The pixel electrodes 16a and 16b are connected to the drain bus line 14 via the TFT 21 and the pixel electrode 17 is connected to the storage capacitor bus line 18n via the TFT 22. Therefore, as in the case of the first embodiment, no burn-in occurs and a liquid crystal display device exhibiting a good viewing angle characteristic can be obtained. Further, better display characteristics can be obtained by setting the capacitance ratio Cc/Clc2 in the range that is different from the conventional range and optimizing the driving method of a liquid crystal display device in consideration of the phenomena that have been newly found in the liquid crystal display device according to this embodiment.

### Third Embodiment

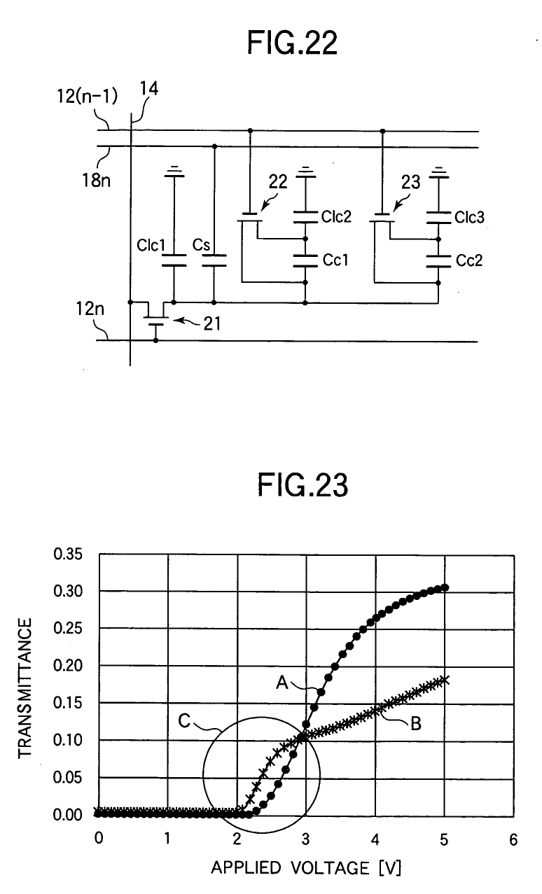

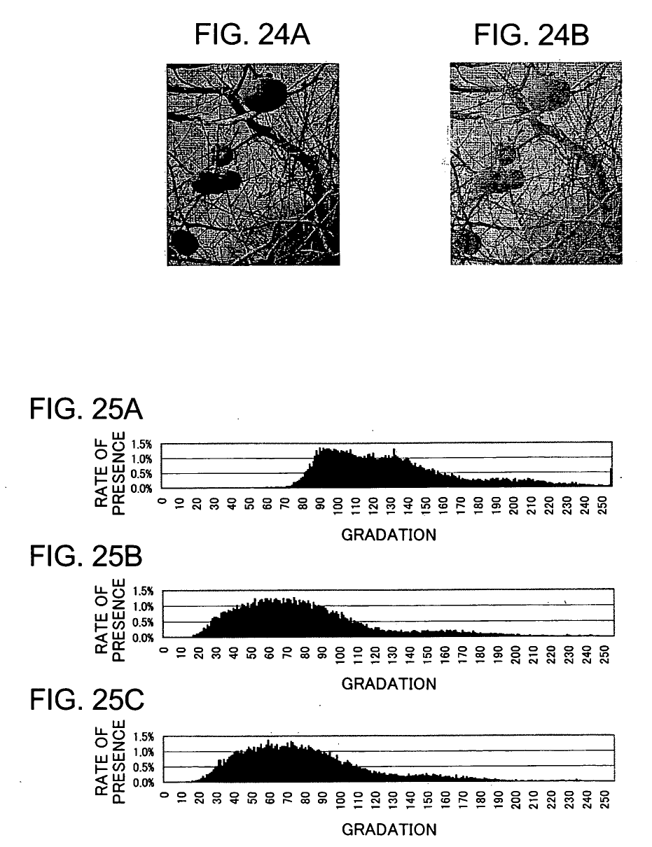

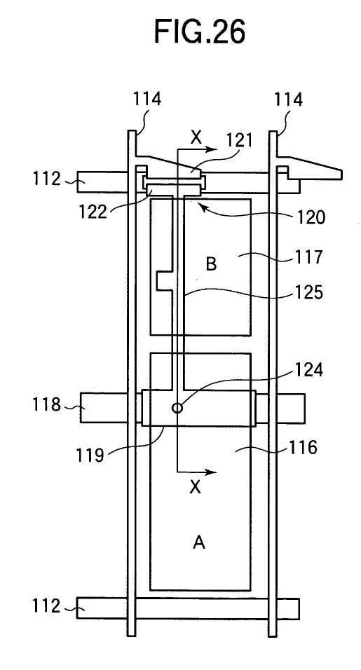

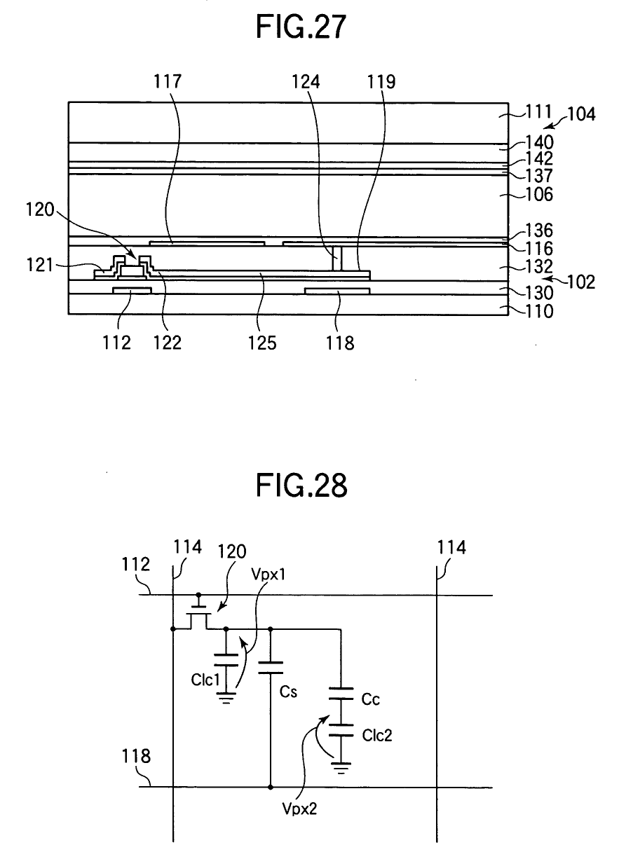

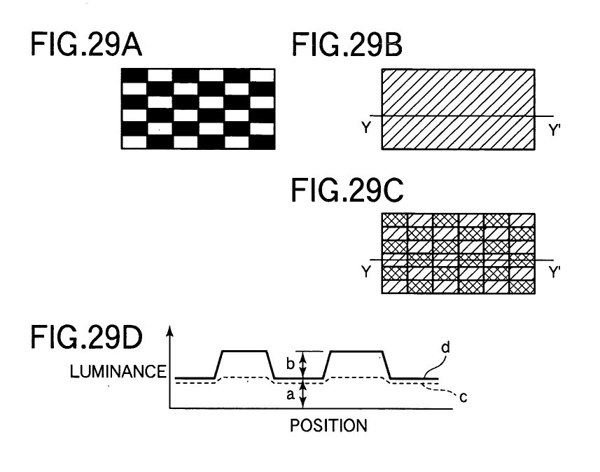

Next, a liquid crystal display device according to a third embodiment of the invention will be described with reference to FIG. 22. Whereas in the first and the second embodiments the pixel region is divided into two kinds of sub-pixels A and B, in this embodiment the pixel region is divided into three (or more) kinds of sub-pixels to further improve the viewing angle characteristic. FIG. 22 shows an equivalent circuit of one pixel of a liquid crystal display device according to this embodiment. As shown in FIG. 22, the liquid crystal display device according to this embodiment is different from that according to the first embodiment (see the equivalent circuit of FIG. 4) in that a second control capacitance Cc2 is provided in the same pixel as a first control capacitance Cc1 (in FIG. 4, the control capacitance Cc) is provided. One electrode of the second control capacitance Cc2 is electrically connected to the source electrode of the TFT 21. The other electrode of the second control capacitance Cc2 is connected to the source electrode of the TFT 21 via a third TFT 23 and is electrically connected to a pixel electrode that is formed in a third sub-pixel C. The pixel electrode formed in the third sub-pixel C and the source electrode of the TFT 21 are capacitance-coupled with each other by the control capacitance Cc2. A liquid crystal capacitance Clc3 is formed between the pixel electrode formed in the third sub-pixel C and the common electrode 42 which is opposed to the pixel electrode via the liquid crystal layer.

Capacitance ratios Cc1/Clc2 and Cc2/Clc3 are set at different values so that voltages Vpx1, Vpx2, and Vpx3 across the portions of the liquid crystal layer located in the sub-pixels A, B, and C are made different from each other. For example, to establish a relationship Vpx1>Vpx2>Vpx3, the capacitance ratios Cc1/Clc2 and Cc2/Clc3 may be set so as to satisfy a relationship Cc1/Clc2>Cc2/Clc3. The pixel region can be divided into four or more kinds of sub-pixels in a similar manner. This embodiment makes it possible to provide a better viewing angle characteristic than the first or the second embodiment does.

The invention is not limited to the above embodiments and various modifications are possible.

For example, although the above embodiments are directed to the liquid crystal display devices of the VA mode such as the MVA mode, the invention is not limited to such a case and can also be applied to liquid crystal display devices of other modes such as the TN mode.

Although the above embodiments are directed to the transmission-type liquid crystal display devices, the invention is not limited to such a case and can also be applied to liquid crystal display devices of other types such as the reflection type and the transflective type.

Although the above embodiments are directed to the liquid crystal display devices in which the CF resin layer 40 is formed in the opposite substrate 4 which is opposite to TFT substrate 2, the invention is not limited to such a case and can also be applied to a liquid crystal display device having what is called a CF-on-TFT structure in which the CF resin layer 40 is formed in the TFT substrate 2.

What is claimed is:

1. A substrate for a liquid crystal display device, comprising:
a plurality of gate bus lines formed parallel with each other on a substrate;
a plurality of drain bus lines formed so as to cross the gate bus lines with an insulating film interposed in between;
a pixel region having a first sub-pixel in which a first pixel electrode is formed on the substrate and a second sub-pixel in which a second pixel electrode is formed on the substrate so as to be separated from the first pixel electrode;
a first transistor having a gate electrode that is electrically connected to an nth one of the gate bus lines, a drain electrode that is electrically connected to one of the drain bus lines, and a source electrode that is electrically connected to the first pixel electrode;
a second transistor having a gate electrode that is electrically connected to an (n−1)th one of the gate bus lines, a drain electrode that is electrically connected to one of the source electrode of the first transistor and the second pixel electrode, and a source electrode that is electrically connected to the other of the source electrode of the first transistor and the second pixel electrode; and
a control capacitance section which has a control capacitance electrode electrically connected to the source electrode of the first transistor and is opposed to at least part of the second pixel electrode via an insulating film, and thereby establishes capacitive coupling between the source electrode of the first transistor and the second pixel electrode.

2. The substrate for a liquid crystal display device according to claim 1, wherein the nth-row pixel region is disposed between the (n−1)th gate bus line and the nth gate bus line.

3. The substrate for a liquid crystal display device according to claim 1, wherein a ratio of an area of the second sub-pixel to that of the first sub-pixel is in a range of ½ to 4.

4. A liquid crystal display device comprising:
a pair of substrates opposed to each other, one of the pair of substrates being the substrate for a liquid crystal display device according to claim 1; and
a liquid crystal sealed between the pair of substrates.

5. The liquid crystal display device according to claim 4, wherein:
the other of the pair of substrates has a common electrode; and
a ratio of a capacitance of the control capacitance section to that of a liquid crystal capacitance formed between the second pixel electrode and the common electrode is in a range of 3.5 to 12.

6. The liquid crystal display device according to claim 5, wherein the capacitance ratio is about 6.

7. The liquid crystal display device according to claim 4, wherein:
the other of the pair of substrates has a common electrode;
the substrate for a liquid crystal display device further comprises a storage capacitor that is connected in parallel to a liquid crystal capacitance formed between the second pixel electrode and the common electrode; and
a ratio of capacitance of the control capacitance section to a sum of capacitance of the liquid crystal capacitance and capacitance of the storage capacitor is in a range of 3.5 to 12.

8. The liquid crystal display device according to claim 7, wherein the capacitance ratio is about 6.

9. A substrate for a liquid crystal display device, comprising:
a plurality of gate bus lines formed parallel with each other on a substrate;
a plurality of drain bus lines formed so as to cross the gate bus lines with an insulating film interposed in between;
a plurality of storage capacitor bus lines formed parallel with the gate bus lines;
a pixel region having a first sub-pixel in which a first pixel electrode is formed on the substrate and a second sub-pixel in which a second pixel electrode is formed on the substrate so as to be separated from the first pixel electrode;
a first transistor having a gate electrode that is electrically connected to an nth one of the gate bus lines, a drain electrode that is electrically connected to one of the drain bus lines, and a source electrode that is electrically connected to the first pixel electrode;
a second transistor having a gate electrode that is electrically connected to an (n−1)th one of the gate bus lines, a drain electrode that is electrically connected to one of the second pixel electrode and one of the storage capacitor bus lines, and a source electrode that is electrically connected to the other of the second pixel electrode and the one of the storage capacitor bus lines; and
a control capacitance section which has a control capacitance electrode electrically connected to the source electrode of the first transistor and is opposed to at least part of the second pixel electrode via an insulating film, and thereby establishes capacitive coupling between the source electrode of the first transistor and the second pixel electrode.

10. The substrate for a liquid crystal display device according to claim 9, wherein the nth-row pixel region is disposed between the (n−1)th gate bus line and the nth gate bus line.

11. The substrate for a liquid crystal display device according to claim 9, wherein a ratio of an area of the second sub-pixel to that of the first sub-pixel is in a range of ½ to 4.

12. A liquid crystal display device comprising:
a pair of substrates opposed to each other, one of the pair of substrates being the substrate for a liquid crystal display device according to claim 9; and
a liquid crystal sealed between the pair of substrates.

13. The liquid crystal display device according to claim 12, wherein:
the other of the pair of substrates has a common electrode; and
a ratio of a capacitance of the control capacitance section to that of a liquid crystal capacitor formed between the second pixel electrode and the common electrode is in a range of 0.5 to 1.3.

14. The liquid crystal display device according to claim 13, wherein the capacitance ratio is about 0.75.

15. The liquid crystal display device according to claim 12, wherein:
the other of the pair of substrates has a common electrode;
the substrate for a liquid crystal display device further comprises a storage capacitor that is connected in parallel to a liquid crystal capacitance formed between the second pixel electrode and the common electrode; and
a ratio of capacitance of the control capacitance section to a sum of capacitance of the liquid crystal capacitance and capacitance of the storage capacitor is in a range of 0.5 to 1.3.

16. The liquid crystal display device according to claim 15, wherein the capacitance ratio is about 0.75.

17. The liquid crystal display device according to claim 4, wherein the liquid crystal has negative dielectric anisotropy and is aligned almost perpendicularly to substrate surfaces when no voltage is applied.

18. A method for driving a liquid crystal display device comprising:
a plurality of gate bus lines formed parallel with each other on a substrate;
a plurality of drain bus lines formed so as to cross the gate bus lines with an insulating film interposed in between;
a pixel region having a first sub-pixel in which a first pixel electrode is formed on the substrate and a second sub-pixel in which a second pixel electrode is formed on the substrate so as to be separated from the first pixel electrode;
a first transistor having a gate electrode that is electrically connected to an nth one of the gate bus lines, a drain electrode that is electrically connected to one of the drain bus lines, and a source electrode that is electrically connected to the first pixel electrode;
a second transistor having a gate electrode that is electrically connected to an (n−1)th one of the gate bus lines, a drain electrode that is electrically connected to one of the source electrode of the first transistor and the second pixel electrode, and a source electrode that is electrically connected to the other of the source electrode of the first transistor and the second pixel electrode; and
a control capacitance section which has a control capacitance electrode electrically connected to the source electrode of the first transistor and is opposed to at least part of the second pixel electrode via an insulating film, and thereby establishes capacitive coupling between the source electrode of the first transistor and the second pixel electrode, the method comprising the steps of:
comparing input gradation data Gm of an mth frame with input gradation data G(m+1) of an (m+1)th frame on a pixel-by-pixel basis; and
if Gm<G(m+1), making a correction so that output gradation data G′(m+1) of the (m+1)th frame satisfies a relationship Gm<G′(m+1)<G(m+1).

19. The method according to claim 18, further comprising the step of:
if Gm>G(m+1), making a correction so that output gradation data G′(m+1) of the (m+1)th frame satisfies a relationship Gm>G′(m+1)>G(m+1).

20. A method for driving a liquid crystal display device comprising:
a plurality of gate bus lines formed parallel with each other on a substrate;
a plurality of drain bus lines formed so as to cross the gate bus lines with an insulating film interposed in between;
a plurality of storage capacitor bus lines formed parallel with the gate bus lines;
a pixel region having a first sub-pixel in which a first pixel electrode is formed on the substrate and a second sub-pixel in which a second pixel electrode is formed on the substrate so as to be separated from the first pixel electrode;
a first transistor having a gate electrode that is electrically connected to an nth one of the gate bus lines, a drain electrode that is electrically connected to one of the drain bus lines, and a source electrode that is electrically connected to the first pixel electrode;
a second transistor having a gate electrode that is electrically connected to an (n−1)th one of the gate bus lines, a drain electrode that is electrically connected to one of the second pixel electrode and one of the storage capacitor bus lines, and a source electrode that is electrically connected to the other of the second pixel electrode and the one of the storage capacitor bus lines; and
a control capacitance section which has a control capacitance electrode electrically connected to the source electrode of the first transistor and is opposed to at least part of the second pixel electrode via an insulating film, and thereby establishes capacitive coupling between the source electrode of the first transistor and the second pixel electrode, the method comprising the steps of:
comparing input gradation data Gm of an mth frame with input gradation data G(m+1) of an (m+1)th frame on a pixel-by-pixel basis; and
if Gm<G(m+1), making a correction so that output gradation data G′(m+1) of the (m+1)th frame satisfies a relationship G′(m+1)>G(m+1).

21. A method for driving a liquid crystal display device comprising:
a plurality of gate bus lines formed parallel with each other on a substrate;
a plurality of drain bus lines formed so as to cross the gate bus lines with an insulating film interposed in between;
a plurality of storage capacitor bus lines formed parallel with the gate bus lines;
a pixel region having a first sub-pixel in which a first pixel electrode is formed on the substrate and a second sub-pixel in which a second pixel electrode is formed on the substrate so as to be separated from the first pixel electrode;
a first transistor having a gate electrode that is electrically connected to an nth one of the gate bus lines, a drain electrode that is electrically connected to one of the drain bus lines, and a source electrode that is electrically connected to the first pixel electrode;
a second transistor having a gate electrode that is electrically connected to an (n−1)th one of the gate bus lines, a drain electrode that is electrically connected to one of the second pixel electrode and one of the storage capacitor bus lines, and a source electrode that is electrically connected to the other of the second pixel electrode and the one of the storage capacitor bus lines; and
a control capacitance section which has a control capacitance electrode electrically connected to the source electrode of the first transistor and is opposed to at least part of the second pixel electrode via an insulating film, and thereby establishes capacitive coupling between the source electrode of the first transistor and the second pixel electrode, the method comprising the steps of:
comparing input gradation data Gm of an mth frame with input gradation data G(m+1) of an (m+1)th frame on a pixel-by-pixel basis; and
if Gm<G(m+1), making a correction so that output gradation data G′(m+1) of the (m+1)th frame satisfies a relationship Gm<G′(m+1)<G(m+1) and that a luminance variation ΔB in the (m+1)th frame becomes less than or equal to 10% of a luminance difference B(m+1)−Bm between luminance B(m+1) obtained on the basis of the input gradation data G(m+1) and luminance Bm obtained on the basis of the input gradation data Gm.
